(19) United States
(12) Patent Application Publication
(10) Pub. No.: US 2015/0169042 A1
(43) Pub. Date: Jun. 18, 2015

(54) LOW POWER INTERFACE FOR A DATA STORAGE DEVICE

(71) Applicant: Sandisk Technologies Inc., Plano, TX (US)

(72) Inventor: EKRAM HOSSAIN BHUIYAN, SAN JOSE, CA (US)

(73) Assignee: Sandisk Technologies Inc., Plano, TX (US)

(21) Appl. No.: 14/108,259

(22) Filed: Dec. 16, 2013

(51) Int. Cl. G06F 1/32; G06F 1/26

(52) U.S. Cl. CPC G06F 1/3296; G06F 1/263

(57) ABSTRACT

A data storage device includes an interface. A method includes charging a voltage at a node of the interface using a first supply voltage. The method further includes partially discharging the voltage to a voltage supply node of the data storage device. The voltage supply node is associated with a second supply voltage.

### FIELD OF THE DISCLOSURE

The present disclosure is generally related to data storage devices and more particularly to interfaces for data storage devices.

### BACKGROUND

Non-volatile data storage devices, such as embedded memory devices and removable memory devices, have enabled increased portability of data and software applications. For example, multi-level cell (MLC) storage elements of a flash memory device may each store multiple bits of data, enhancing data storage density as compared to single-level cell (SLC) flash memory devices. As a result, flash memory devices may enable users to store and access a large amount of data.

To store and access data, a flash memory device may include an interface that enables data communication. For example, a flash memory device may include an interface that communicates data between the flash memory device and another device, such as a host device that accesses the flash memory device. As another example, a flash memory device may include a memory array and a controller that communicate via an interface. The interfaces consume power during operation, such as by activating transistors and other components to send and receive signals. The power consumption reduces battery life of a portable electronic device.

### SUMMARY

Certain integrated circuits lower power consumption by using a reduced supply voltage. To illustrate, a particular integrated circuit may use a 0.8 volt supply voltage instead of a 1.8 volt supply voltage to operate transistors of the integrated circuit. Using such a reduced supply voltage may cause the transistors and other components to consume less power, which may extend battery life of a portable electronic device that includes the integrated circuit. However, in certain cases, use of a reduced supply voltage may result in use of additional circuitry (e.g., “low threshold” transistors), which may cause a die size of the integrated circuit to increase, and potentially exceed a design specification of the integrated circuit. Further, some circuits may include “high power” devices that are not suitable for operating using a reduced supply voltage. As a particular example, a flash memory array may be designed to operate using a “normal” (or non-reduced) supply voltage.

An interface power consumption reduction technique may be used by a data storage device that includes an interface, such as an interface between a controller and a memory. The interface may be associated with a first voltage domain. For example, the interface may be supplied with an interface supply voltage. The interface may be connected to a power supply node of another voltage domain, such as reduced supply voltage domain. As an example, the power supply node may supply a core supply voltage to core circuitry of the data storage device. A voltage level of the core supply voltage may be less than a voltage level of the interface supply voltage.

The interface may be configured to send data that transitions between a voltage level of the interface supply voltage and a voltage level of the core supply voltage (e.g., instead of transitioning between the voltage level of the interface supply voltage and a ground or “zero” voltage level). For example, the interface supply voltage may be used to send a logical “1” value via the interface, and the core supply voltage may be used to send a logical “0” value via the interface. When the data transitions from a logical “1” value to a logical “0” value, a voltage at a node of the interface may transition from the interface supply voltage to the core supply voltage. For example, to transition from the logical “1” value to the logical “0” value, the voltage at the node of the interface may be partially discharged via a discharge current. The partially discharged voltage may be “reused” by providing the partially discharged voltage to another voltage domain via the discharge current, such as to the core circuitry of the data storage device. “Reusing” the partially discharged voltage in such a manner may reduce power consumption of the data storage device as compared to devices that discharge a voltage to ground to indicate a bit transition to a logical “0” value.

### BRIEF DESCRIPTION OF THE DRAWINGS

FIG. 1 is a diagram of a particular illustrative embodiment of an electronic device that includes a data storage device;

FIG. 2 is a diagram of a circuit that may be included in the electronic device of FIG. 1;

FIG. 3 is a diagram of a circuit that may be included in the electronic device of FIG. 1, such as in the circuit of FIG. 2;

FIG. 4 is a diagram of another circuit that may be included in the electronic device of FIG. 1, such as in the circuit of FIG. 2;

FIG. 5 is a diagram of another particular illustrative embodiment of an electronic device that includes a data storage device;

FIG. 6 is a flow diagram of a particular illustrative embodiment of a method of operating the electronic device of FIG. 1, the electronic device of FIG. 5, or a combination thereof.

### DETAILED DESCRIPTION

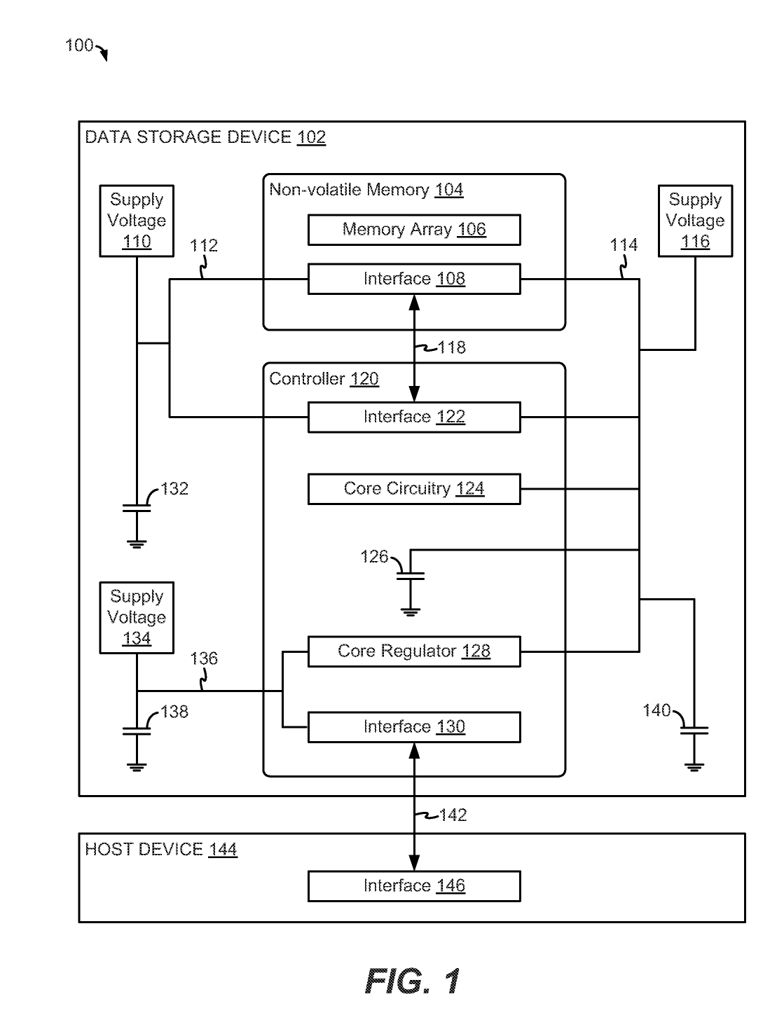

Referring to FIG. 1, a particular illustrative embodiment of an electronic device is depicted and generally designated 100. The electronic device 100 includes a data storage device 102 and a host device 144. The data storage device 102 may be embedded within the host device 144, such as in accordance with a Joint Electron Devices Engineering Council (JEDEC) Solid State Technology Association Universal Flash Storage (UFS) configuration. Alternatively, the data storage device 102 may be removable from (i.e., “removably” coupled to) the host device 144. For example, the data storage device 102 may be removably coupled to the host device 144 in accordance with a removable universal serial bus (USB) configuration.

The data storage device 102 may include a memory (e.g., a non-volatile memory 104) and a controller 120. The non-volatile memory 104 may include a memory array 106 and an interface 108. The interface 108 may be coupled to a node 112 and to a node 114. The node 112 may be configured to receive a supply voltage 110, and the node 112 may be coupled to a capacitor 132. The node 114 may be configured to receive a supply voltage 116, and the node 114 may be coupled to a capacitor 140.

The controller 120 may include an interface 122, core circuitry 124, a capacitor 126 (e.g., an on-die capacitor), a core regulator 128, and an interface 130. The interface 122 may be communicatively coupled to the interface 108 via a connection 118. The interface 122 may be coupled to the nodes 112, 114. The interface 122 may be responsive to the supply voltages 110, 116 via the nodes 112, 114. The core regulator 128 may be coupled to the node 114 and further coupled to a node 136. The node 136 may be configured to receive a supply voltage 134. The node 136 may be coupled to a capacitor 138.

The core circuitry 124 may include one or more components that perform and/or control certain operations at the data storage device. For example, the core circuitry 124 may include an error correction code (ECC) encoder, an ECC decoder, a random access memory (RAM), a read-only memory (ROM), a non-volatile memory (NVM), a processor, such as a central processing unit (CPU), or a combination thereof, as illustrative examples.

The non-volatile memory 104 and the controller 120 may be coupled via the connection 118. The connection 118 may include a node that is common to the interfaces 108, 122. For example, the connection 118 may include an output node that is common to the interfaces 108, 122. In a particular embodiment, the connection 118 is a flash interface module (FIM) bus that includes one or more nodes, such as an output node that is common to the interfaces 108, 122.

The host device 144 may include an interface 146. The host device 144 may be communicatively coupled to the data storage device 102 via a connection 142. For example, the connection 142 may communicatively couple the interfaces 130, 146. The connection 142 may include a node that is common to the interfaces 130, 146.

The controller 120 is configured to receive data and instructions from the host device 144 via the connection 142 and to send data to the host device 144 via the connection 142. For example, the controller 120 may send data to the host device 144 via the connection 142 and may receive data from the host device 144 via the connection 142. The controller 120 may store (e.g., buffer) data at a cache or a memory, such as a random access memory (RAM) included in the core circuitry 124 (not shown).

The controller 120 is configured to send data and commands to the non-volatile memory 104 via the connection 118 and to receive data from the non-volatile memory 104 via the connection 118. For example, the controller 120 is configured to send data and a write command via the connection 118 to cause the non-volatile memory 104 to store the data to a specified address of the memory array 106. The data may include one or more error correcting code (ECC) codewords generated by an ECC encoder (not shown) of the core circuitry 124.

The controller 120 is configured to send a read command via the connection 118 to sense data from a specified address of the non-volatile memory 104. As an example, the controller 120 may send a read command to sense data stored at the memory array 106. The core circuitry 124 may include an ECC decoder (not shown) that is configured to decode the data sensed from the memory array 106.

The host device 144 may correspond to a mobile telephone, a music player, a video player, a gaming device or console, an electronic book reader, a personal digital assistant (PDA), a computer, such as a laptop, a tablet, or a notebook computer, a portable navigation device, another electronic device, or a combination thereof. The host device 144 may communicate via a host controller, which may enable the host device 144 to communicate with the data storage device 102 via the interface 146. The host device 144 may operate in compliance with a JEDEC Solid State Technology Association industry specification, such as an embedded MultiMedia Card (eMMC) specification or a Universal Flash Storage (UFS) Host Controller Interface specification. The host device 144 may operate in compliance with one or more other specifications, such as a Secure Digital (SD) Host Controller specification as an illustrative example. Alternatively, the host device 144 may communicate with the data storage device 102 in accordance with another communication protocol.

The data storage device 102 may include multiple voltage domains. For example, a first voltage domain may include one or more components of the data storage device 102 that are supplied by the supply voltage 110. The first voltage domain may include the interfaces 108, 122. The data storage device 102 may further include a second voltage domain that includes one or more components supplied by the supply voltage 116. The second voltage domain may include the core circuitry 124. The data storage device 102 may include a third voltage domain that includes one or more components supplied by the supply voltage 134. The third voltage domain may include the core regulator 128 and the interface 130. In a particular embodiment, the second voltage domain is configured to operate using a reduced supply voltage. To illustrate, in a particular embodiment, the supply voltages 110, 134 are approximately 1.8 volts, and the supply voltage 116 is approximately 0.9 volts. In another example configuration, the supply voltage 134 is approximately 1.2 volts. It should be appreciated that the voltage levels of the supply voltages 110, 116, and 134 may depend on the particular application.

In an alternative embodiment, the node 136 is coupled to the supply voltage 110 instead of the supply voltage 134. For example, the supply voltage 110 and the supply voltage 134 may correspond to a single supply voltage. Alternatively, the supply voltages 110, 134 may correspond to separate supply voltages.

In operation, one or more communications may be sent and received at the interfaces 108, 122 via the connection 118. For example, the controller 120 may charge and discharge voltages at the connection 118 to indicate bit transitions of data and other communications to the non-volatile memory 104. As another example, the non-volatile memory 104 may charge and discharge voltages at the connection 118 to indicate bit transitions of data and other communications to the controller 120.

As referred to herein, charging a voltage at a node may include applying (e.g., accumulating) charge at the node. For example, the node may be biased using a supply voltage (e.g., one of the supply voltages 110, 116, and 134) to increase the voltage at the node to a target voltage level (e.g., to within a target voltage level range). The voltage at the node may be discharged by coupling the node (e.g., via a transistor) to a ground node (or to another node, such as a “virtual ground” node) in order to release the charge by generating a discharge current. As referred to herein, the voltage at the node may be partially discharged by releasing a portion of the charge (but not all of the charge) via the discharge current. As an illustrative example, a voltage at a node may be charged by biasing the node to 1.8 volts. After biasing the node, the voltage at the node may be partially discharged by releasing charge from the node via a discharge current such that the voltage at the node is decreased from 1.8 volts to 0.9 volts. The discharge current may have a particular magnitude that corresponds to a reduction of the voltage from 1.8 volts to 0.9 volts.

In FIG. 1, the interfaces 108, 122 may be supplied via the supply voltage 110. For example, while sending communications, the interfaces 108, 122 may charge a voltage at the connection 118 using the supply voltage 110. In FIG. 1, voltages at the connection 118 may be partially discharged via a discharge current to a voltage supply node of the data storage device 102. For example, the voltage supply node may correspond to the node 114. In this manner, current from the interfaces 108, 122 may be “reused” by the supply voltage 116. For example, by partially discharging a voltage charged at the connection 118 via the discharge current, a voltage level of the supply voltage 116 may be increased. In a particular embodiment, the discharge current is provided to the core circuitry 124.

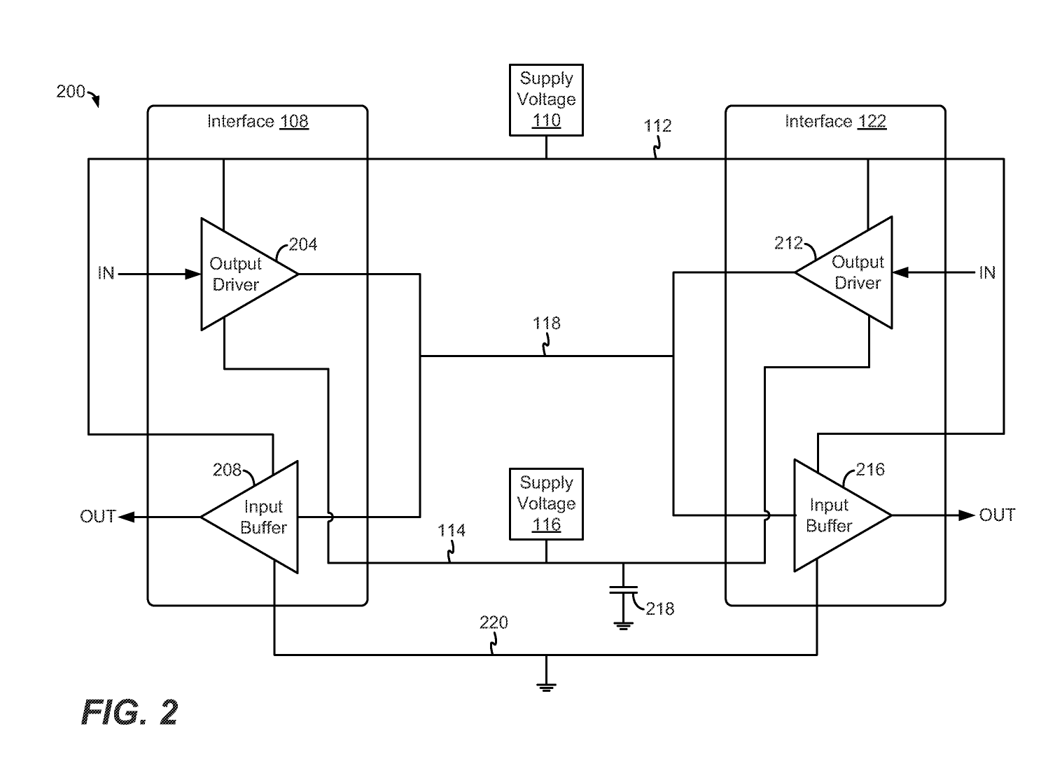

Reusing the discharge current may conserve power at the electronic device 100. For example, as illustrated in more detail with reference to FIG. 2, coupling the interfaces 108, 122 to the supply voltage 116 via the node 114 may enable signals communicated at the interfaces 108, 122 to transition (or “swing”) between voltage levels associated with the supply voltages 110, 116 instead of transitioning between a voltage level of the supply voltage 110 and a ground potential.

To further illustrate, in a particular illustrative embodiment, signals communicated at the interfaces 108, 122 transition between 1.8 volts and 0.9 volts instead of transitioning between 1.8 volts and 0 volts. In this example, transitioning from 1.8 volts to 0.9 volts conserves power as compared to transitioning from 1.8 volts to 0 volts (e.g., by not discharging 1.8 volts to ground). Further, the 0.9 volts discharged based on the 1.8 volt to 0.9 volt transition may be provided to another voltage domain of the data storage device 102. For example, the discharged voltage may be provided to the core circuitry 124 via the node 114, as described further with reference to FIG. 2. Accordingly, power management is improved at the data storage device 102, which may extend battery life of a portable electronic device, such as by extending battery life of a battery that is included in the electronic device 100 and that powers the data storage device 102 (e.g., by providing one or more of the supply voltages 110, 116, and 134).

Referring to FIG. 2, a particular illustrative embodiment of a circuit is depicted and generally designated 200. In a particular embodiment, the circuit 200 is located within the electronic device 100, such as within the data storage device 102. The circuit 200 may include the interfaces 108, 122. The interfaces 108, 122 may be coupled to the nodes 112, 114 and to the connection 118. The node 112 may be responsive to the supply voltage 110, and the node 114 may be responsive to the supply voltage 116.

The interface 108 may include an output driver 204 and an input buffer 208. The interface 122 may include an output driver 212 and an input buffer 216. In a particular embodiment, the input buffers 208, 216 each include one or more comparator circuits. The comparator circuits may be configured to determine bit transitions of signals sent via the connection 118 by comparing relative voltage levels of the signals (e.g., by detecting changes within a signal) or by matching voltage levels of the signal to a reference voltage to determine a particular bit value of the signal.

The input buffers 208, 216 may be coupled to a ground node 220. The node 114 may be coupled to a capacitor 218. The capacitor 218 may correspond to the capacitor 140, or to a capacitor that is distinct from the capacitor 140.

The particular example of FIG. 2 illustrates that the connection 118 includes a single node. The single node may correspond to a serial interface configured to serially communicate multiple bits of data. It should further be appreciated that the techniques described herein are applicable to a variety of interfaces. For example, in another embodiment, the connection 118 may include multiple nodes (e.g., in connection with a parallel interface configured to communicate multiple bits of data in parallel). One or more of the multiple nodes may be coupled to the nodes 112, 114. The connection 118 may correspond to a synchronous interface that further includes a clock signal connection that communicates a clock signal. The clock signal may be communicated via the clock signal connection concurrently with data bits (serially or in parallel) that are communicated via the connection 118. Alternatively, the connection 118 may correspond to an asynchronous interface that does not communicate a clock signal concurrently with data bits (serially or in parallel). The connection 118 may include a command connection that is configured to communicate commands and/or command responses between the controller 120 and the non-volatile memory 104. Alternatively, commands and/or command responses may be communicated via a single connection that also communicates data. Those of skill in the art will recognize that other configurations are within the scope of the disclosure. It will further be appreciated that the foregoing illustrative descriptions are also be applicable to the connection 146 of FIG. 1.

In operation, the output drivers 204, 212 may send one or more signals via the connection 118 that are received at the input buffers 216, 208, respectively. To send a signal, the output driver 204 may charge a voltage at a node (e.g., an output node) of the connection 118 using the supply voltage 110. For example, by charging the voltage at the connection 118, the input buffer 216 may receive a logical “1” value.

To send a logical “0” value, the output driver 204 may discharge or partially discharge the voltage at the connection 118. To illustrate, the output driver 204 may partially discharge the voltage at the connection 118 by coupling the connection 118 to the node 114. If the voltage at the connection 118 is greater than a positive voltage level of the supply voltage 116 (e.g., if a positive voltage level of the supply voltage 110 is greater than a positive voltage level of the supply voltage 116), the voltage at the connection 118 may partially discharge to the node 114.

By partially discharging the voltage at the connection 118, a current may be generated from the connection 118 to the node 114. The current may be reused at another voltage domain of the data storage device 102. In a particular embodiment, the current is reused to power the core circuitry 124. Further, the circuit 200 may enable a reduced voltage swing of output signals sent via the connection 118. For example, if the supply voltage 110 has a voltage level of approximately 1.8 volts and if the supply voltage 116 has a voltage level of approximately 0.9 volts, the circuit 200 may reduce power consumption as compared to a device that transitions between 1.8 volts and 0 volts. The reduced power consumption may be enabled without use of dedicated low power circuitry (e.g., low threshold voltage transistors), reducing circuit area and cost associated with the circuit 200.

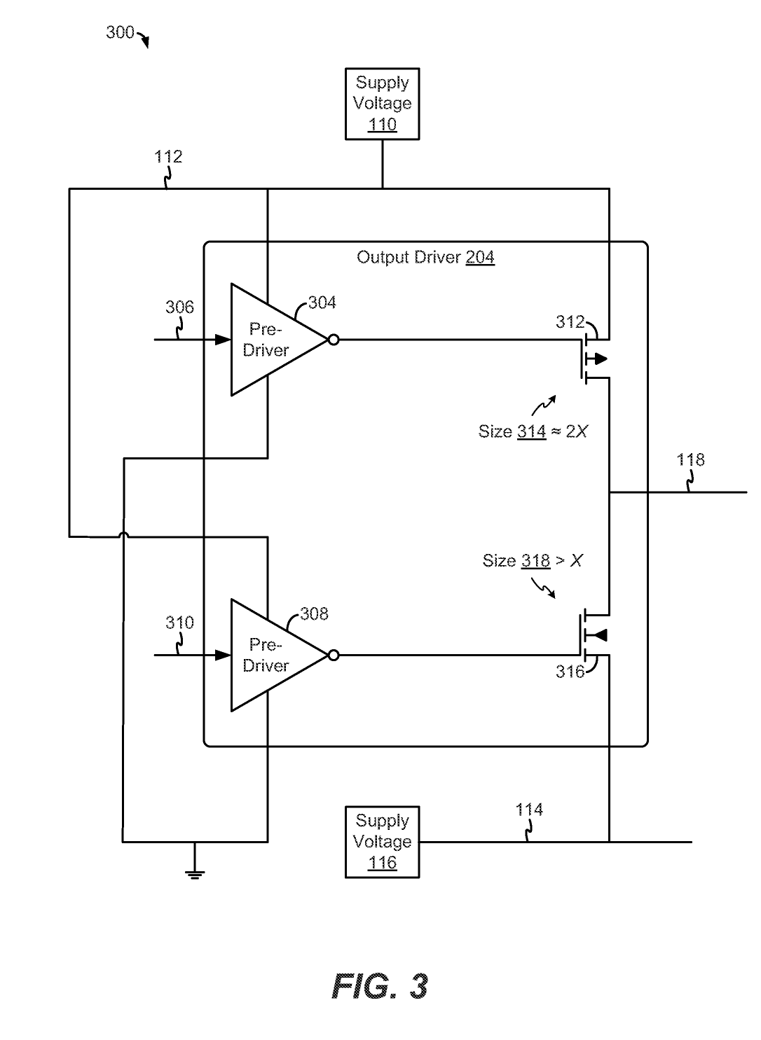

Referring to FIG. 3, a particular illustrative embodiment of a circuit is depicted and generally designated 300. The circuit 300 may be located within the electronic device 100, such as within the data storage device 102. In a particular embodiment, the circuit 300 is implemented within the circuit 200.

The circuit 300 may include the output driver 204. The output driver 204 may be coupled to the nodes 112, 114. For example, the output driver 204 may be coupled to receive the supply voltage 110 via the node 112. The node 114 may be responsive to the supply voltage 116. The output driver 204 may be further coupled to the connection 118.

The output driver 204 may include a pre-driver 304, a pre-driver 308, a p-type metal-oxide-semiconductor field-effect transistor (pMOSFET) 312, and an n-type metal-oxide-semiconductor field-effect transistor (nMOSFET) 316. The pre-drivers 304, 308 may each include an inverter, such as a complementary metal-oxide-semiconductor (CMOS) inverter. The pre-driver 304 may be responsive to a signal 306, and the pre-driver 308 may be responsive to a signal 310. The signal 306 may correspond to a logical “1” value of data or another signal that is to be communicated via the connection 118, and the signal 310 may correspond to a logical “0” value of the data or other signal.

In the particular example of FIG. 3, the pMOSFET 312 has a size 314 that is approximately 2X where X is a positive integer that may indicate an approximate size of a typical n-type input/output (I/O) transistor of the data storage device 102. X may indicate a transistor length-to-width (L/W) ratio. The nMOSFET 316 may have a size 318. The size 318 may be greater than X To illustrate, because the nMOSFET 316 is coupled to the supply voltage 116 instead of to a ground node, the size 318 may be increased as compared to one or more other n-type I/O transistors (which may have a size of approximately X) in order to facilitate a discharge current through the nMOSFET 316. For example, the size 318 may be selected to compensate for a reduced source-to-drain voltage of the nMOSFET 316 and to compensate for a reduced gate-to-source voltage of the nMOSFET 316. The size 318 of the nMOSFET 316 may be greater than the size 314 of the pMOSFET 312. In a particular embodiment, the size 318 is at least 2X and is not greater than 3X though the particular value of the size 318 depends on the application (e.g., the size 318 may be less than 2X or greater than 3X in certain cases).

In operation, the pre-driver 304 may receive the signal 306. The signal 306 may have a logical “1” value. The pre-driver 304 inverts the logical “1” value to generate a logical “0” value, activating the pMOSFET 312. Upon activation, the pMOSFET 312 couples the connection 118 to the node 112. Accordingly, the pMOSFET 312 may charge a voltage at the connection 118 via the supply voltage 110.

The pre-driver 308 may be responsive to the signal 310. If the signal 310 has a logical “0” value, the pre-driver 308 inverts the logical “0” value to generate a logical “1” value, activating the nMOSFET 316. Upon activation, the nMOSFET 316 couples the connection 118 to the node 114, partially discharging the voltage at the connection 118 to generate a current. The current may be reused at another portion of the data storage device 102 that is not shown in FIG. 3. As an illustrative example, the current may be provided to the core circuitry 124.

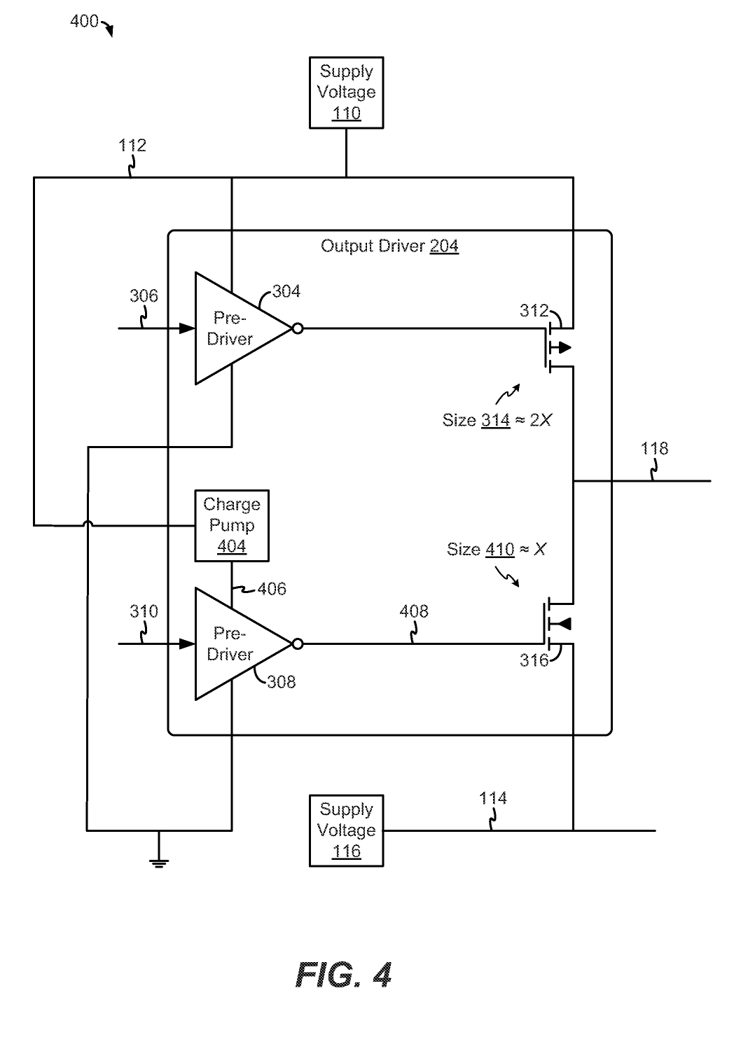

The circuit 300 may be implemented in a circuit in which the size 318 of the nMOSFET 316 may exceed X, such as in an integrated circuit design that is not “pad-limited.” By increasing the size 318 to exceed X, the nMOSFET 316 may conduct a sufficient amount of current (e.g., by conducting at least a particular magnitude of current) to partially discharge a voltage at the connection 118, conserving power at the circuit 300. In other designs, circuit area may be constrained. For example, in certain “pad-limited” circuit designs, increasing transistor size may be infeasible. In such a circuit design, a charge pump may be utilized to overdrive the nMOSFET 316 to cause the nMOSFET 316 to conduct a sufficient amount of current to “pull down” a voltage at the connection 118 to a voltage level of the node 114, as described further with reference to FIG. 4.

Referring to FIG. 4, a particular illustrative embodiment of a circuit is depicted and generally designated 400. The circuit 400 may be implemented within the electronic device 100, such as within the data storage device 102. In a particular embodiment, the circuit 400 is implemented within the circuit 200.

Certain components and operations of the circuit 400 may be as described with reference to FIGS. 1-3. For example, the circuit 400 may include the output driver 204. The output driver 204 may be coupled to receive the supply voltage 110 via the node 112. The output driver 204 may be coupled to the connection 118 and to the node 114. The node 114 may be responsive to the supply voltage 116.

In the example of FIG. 4, the output driver 204 includes a charge pump 404. The charge pump 404 is coupled to the node 112. The charge pump 404 is further coupled to the pre-driver 308. It should be appreciated that although the example of FIG. 4 illustrates that the output driver 204 includes the charge pump 404, the charge pump 404 may be located externally to the output driver 204 (e.g., as part of the core circuitry 124, or at another portion of the data storage device 102). In the particular example of FIG. 4, the nMOSFET 316 has a size 410, and the pMOSFET 312 has the size 314.

In operation, the charge pump may be responsive to the supply voltage 110 to generate an overdrive signal 406. The overdrive signal 406 may overdrive the pre-driver 308 when the signal 310 has a logical “0” value, causing the pre-driver 308 to generate an overdrive signal 408. The overdrive signal 408 may activate a gate terminal of the nMOSFET 316. In a particular embodiment, the overdrive signal 406 has a voltage level that is approximately twice a voltage level of the supply voltage 110. The overdrive signal 408 may ensure that the nMOSFET 316 conducts a sufficient amount (e.g., magnitude) of current to reduce a voltage at the connection 118 to a voltage level of the node 114 when the signal 310 has a logical “0” value.

Because the overdrive signal 408 causes the nMOSFET 316 to conduct a sufficient amount of current to partially discharge a voltage from the connection 118, the size 410 of the nMOSFET 316 may be less than the size 314 of the pMOSFET 312. In the particular illustrative example of FIG. 4, the size 410 of the nMOSFET 316 is approximately half the size 314 of the pMOSFET 312. For example, the size 410 of the nMOSFET 316 may be similar to sizes of other n-type I/O transistors of the data storage device 102. Thus, the circuit 400 may be implemented in a device in which reduction of transistor size is advantageous (e.g., in a “pad-limited” integrated circuit). In addition, maintaining a common size of the n-type I/O transistors may simplify a fabrication process used to fabricate the circuit 400 (e.g., by using a common CMOS process for the n-type I/O transistors). Circuit area of the output driver 204 can be further reduced by relocating the charge pump 404 externally relative to the output driver 204 (e.g., within the core circuitry 124, or elsewhere in the data storage device 102), further reducing a circuit area of the circuit 400.

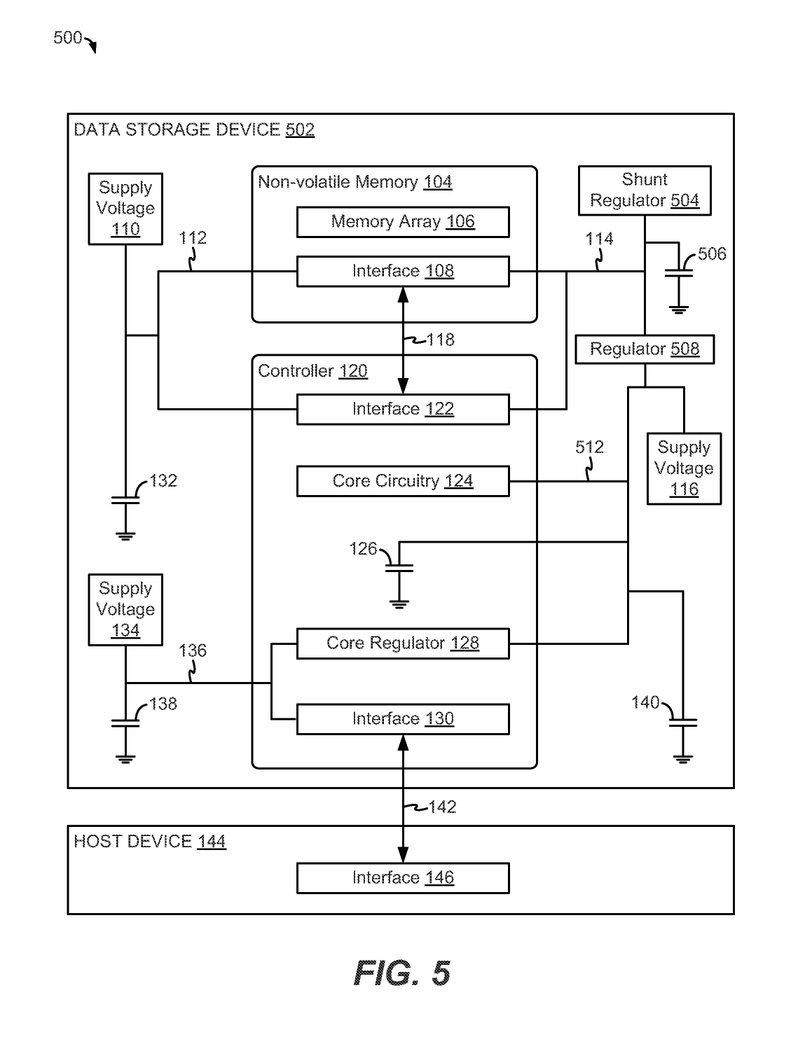

Referring to FIG. 5, a particular illustrative embodiment of an electronic device is depicted and generally designated 500. The electronic device 500 includes a data storage device 502. Certain components and operations of the electronic device 500 may be as described with reference to the electronic device 100. For example, the electronic device 500 may include the host device 144. The data storage device 502 may include the non-volatile memory 104, the controller 120, the nodes 112, 114, and 136, the capacitors 132, 138, and 140, and the connections 118, 142. The data storage device 502 may be responsive to the supply voltages 110, 116, 134. Components and operations of the non-volatile memory 104, the controller 120, and the host device 144 may be as described with reference to FIG. 1.

In FIG. 5, the data storage device 502 further includes a shunt regulator 504 that is coupled to the node 114 and a regulator 508 that is coupled to the node 114. The regulator 508 is further coupled to a node 512. The regulator 508 may include a boost regulator, a charge pump, a low drop-out (LDO) regulator, or a combination thereof. The data storage device 502 may further include a capacitor 506 coupled to the node 114. The capacitor 506 may correspond to the capacitor 218, or another capacitor that is distinct from the capacitor 218.

In operation, a voltage at the node 114 may be different than a voltage at the node 512. To illustrate, in a particular example, the voltage at the node 114 may be approximately 1.0 volts, and the voltage at the node 512 may be approximately 0.9 volts. In one or more other examples, the voltage at the node 114 may be less than a voltage at the node 512. As a non-limiting example, the voltage at the node 114 may be approximately 0.8 volts, and the voltage at the node 512 may be approximately 0.9 volts.

The shunt regulator 504 and/or the regulator 508 may regulate the voltage at the node 114 to a voltage level of a voltage domain associated with the node 512. For example, the shunt regulator 504 may attenuate the voltage at the node 114 (e.g., by discharging current), and/or the regulator 508 may boost (or “step up”) the voltage to a voltage level of a voltage domain associated with the node 512 (e.g., to a voltage level of the supply voltage 116). To further illustrate, in certain cases, the voltage at the connection 118 may discharge to a voltage that is lower than the voltage level of the supply voltage 116. In this case, the shunt regulator 504 may regulate the voltage at the node 114 and the regulator 508 (or a charge pump or a boost regulator of the regulator 508) may boost the voltage at the node 114 to the voltage level of the supply voltage 116. As an illustrative example, the regulator 508 may boost the voltage at the node 114 from approximately 0.8 volts to approximately 0.9 volts. In the example of FIG. 5, the 0.9 volt signal may be provided to the node 512 and may be “re-used” to power the core circuitry 124.

The configuration illustrated with reference to FIG. 5 may be advantageous in certain implementations in which data transitions at the connection 118 do not swing low enough to “reach” a voltage level of the supply voltage 116. For example, depending on a particular design specification, the size 318 of the nMOSFET 316 may be such that the nMOSFET 316 is unable to pull down a voltage at the connection 118 to a voltage level of the supply voltage 116. In such an example, the shunt regulator 504 and the regulator 508 may attenuate the voltage at the node 114 to a voltage level of the supply voltage 116 (e.g., from 1.0 volts to 0.9 volts).

As another example, depending on a particular design specification, the charge pump 404 may be insufficient to cause the nMOSFET 316 to pull down a voltage at the connection 118 to a voltage level associated with the supply voltage 116. In this case, the nMOSFET 316 may output a voltage to the node 114 that is greater than a voltage level of the supply voltage 116. In this example, the shunt regulator 504 and the regulator 508 may attenuate the voltage at the node 114 to a voltage level of the supply voltage 116 (e.g., from 1.0 volts to 0.9 volts).

Accordingly, the configuration illustrated with reference to FIG. 5 may be advantageous in certain implementations in which a voltage at the connection 118 does not transition low enough to reach a voltage level of the supply voltage 116. For example, the voltage at the connection 118 may “swing” from 1.8 volts to 1.0 volts during a bit transition to a logical “0” value. If the supply voltage 116 is less than 1.0 volts (e.g., is 0.9 volts or less), the shunt regulator 504 and the regulator 508 may be utilized to attenuate the voltage. In the particular example of FIG. 5, the data storage device 502 is configured to “re-use” the attenuated voltage by providing the attenuated voltage to the core circuitry 124.

In one or more other examples, the voltage at the connection 118 may discharge to a voltage level that is lower than the voltage level associated with the supply voltage 116. In this case, the regulator 508 may boost the voltage at the node 114 to the voltage level associated with the supply voltage 116. As a particular non-limiting example, the regulator 508 may boost the voltage from approximately 0.8 volts to approximately 0.9 volts. The boosted voltage may be provided to (or “reused” at) the core circuitry 124. FIG. 5 therefore describes power management techniques that are applicable to a data storage device having multiple voltage domains.

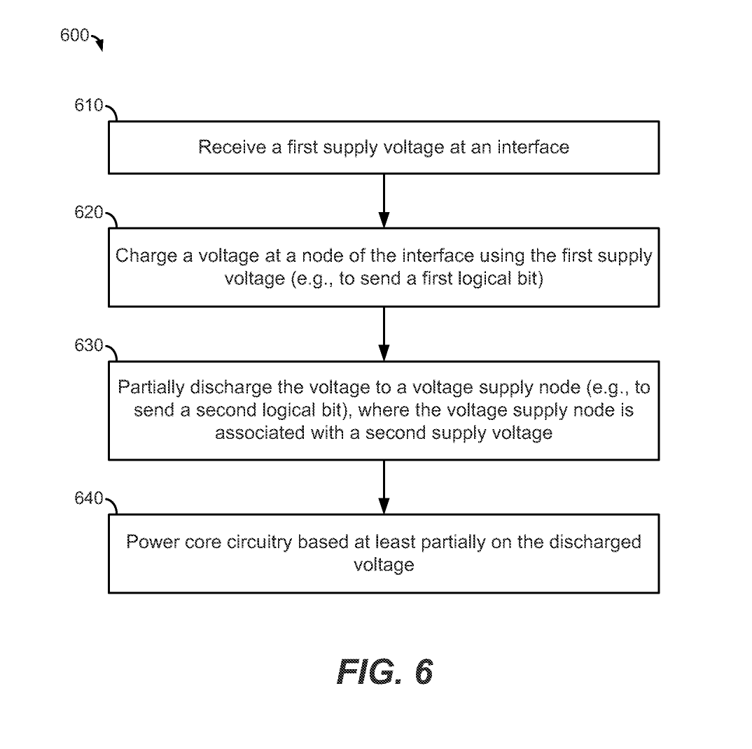

Referring to FIG. 6, a particular illustrative embodiment of a method is depicted and generally designated 600. The method 600 may be performed at an electronic device, such as at the electronic device 100, the electronic device 500, or a combination thereof. To further illustrate, the method 600 may be performed at the interface 108 and/or at the interface 122. For example, the method 600 may be performed by the interface 108, such as while the non-volatile memory 104 is sending a signal to the controller 120. Alternatively or in addition, the method 600 may be performed by the interface 122, such as while the controller 120 is sending a signal to the non-volatile memory 104.

The method 600 may include receiving a first supply voltage at an interface, at 610. The first supply voltage may correspond to the supply voltage 110, and the interface may correspond to one or more of the interfaces 108, 122. The first supply voltage may be an interface supply voltage that supplies an interface voltage domain (e.g., a voltage domain that is coupled to the node 112).

The method 600 may further include charging a voltage at a node of the interface using the first supply voltage, at 620. The node may correspond to an output node of the interface. The node may correspond to the connection 118, or the node may be included in the connection 118. Charging the voltage at the node may send a first logical bit, such as logical “1” bit. The voltage may be charged at the node by activating the pMOSFET 312. For example, the pre-driver 304 may activate a gate terminal of the pMOSFET 312 in response to the signal 306 having a logical “1” value, causing the pMOSFET 312 to couple the connection 118 to the node 112.

The method 600 may further include partially discharging the voltage to a voltage supply node, at 630. The voltage supply node is associated with a second supply voltage. For example, the voltage supply node may correspond to the node 114 and/or the node 512, and the second supply voltage may correspond to the supply voltage 116. The second supply voltage may be a core supply voltage that supplies a core voltage domain (e.g., a voltage domain that is coupled to the node 114 or to the node 512). Partially discharging the voltage may send a second logical bit, such as a logical “0” bit. The voltage may be partially discharged from the node by activating the nMOSFET 316. For example, the pre-driver 308 may activate a gate terminal of the nMOSFET 316 in response to the signal 310 having a logical “0” value, causing the nMOSFET 316 to couple the connection 118 to the node 114.

The method 600 may further include powering core circuitry based at least partially on the discharged voltage, at 640. For example, a discharge current may be generated that partially discharges the voltage at the node. The discharge current may have a magnitude that reduces the voltage at the node by releasing some (but not all) charge at the node. The core circuitry may correspond to the core circuitry 124. The core circuitry may include an error correction code (ECC) encoder, an ECC decoder, a random access memory (RAM), a read-only memory (ROM), a non-volatile memory (NVM), a processor, such as a central processing unit (CPU), or a combination thereof, as illustrative examples. It should be appreciated that the discharged voltage may be reused at one or more other voltage domains alternatively or in addition to the core circuitry without departing from the scope of the disclosure.

The method 600 enables improved power management at a data storage device, such as improved power management without additional circuitry (e.g., “low voltage” devices). Power consumption at an interface is improved by partially discharging a voltage via a discharge current that is provided to a power supply node, such as the node 114 (instead of fully discharging the voltage to a ground node). The partially discharged voltage can be reused at another voltage domain of the data storage device, such as at a voltage domain that includes the core circuitry 124.

Certain descriptions have been simplified herein for convenience of illustration. For example, certain components, techniques, and operations have been described with reference to the interfaces 108, 122. It will be appreciated that components, techniques, and operations described herein may be applied to one or more of the interfaces 130, 146 without departing from the scope of the disclosure. Alternatively or in addition, one or more components, techniques, and operations may be applied to one or more other interfaces not shown in FIGS. 1 and 5.

Although one or more components described herein are illustrated as block components and described in general terms, such components may include one or more microprocessors, state machines, or other circuits configured to enable the data storage device 102 (or one or more components thereof) to perform operations described herein. For example, one or more components described herein may correspond to one or more physical components, such as hardware controllers, state machines, logic circuits, one or more other structures, or a combination thereof, to enable the controller 120 to perform one or more operations described herein. One or more aspects of the controller 120 may be implemented using a microprocessor or microcontroller programmed to perform operations described herein, such as one or more operations of the method 600. In a particular embodiment, the controller 120 includes a processor executing instructions that are stored at the non-volatile memory 104. Alternatively or in addition, executable instructions that are executed by the processor may be stored at a separate memory location that is not part of the non-volatile memory 104, such as at a read-only memory (ROM).

To further illustrate, the controller 120 may include a processor that is configured to execute instructions to perform certain operations described herein. The processor may execute the instructions to charge a voltage at a node of an interface using a first supply voltage. For example, the processor may execute one or more instructions to cause the controller 120 to send data or another signal via the interface 122. As a particular example, the processor may execute one or more instructions to cause the controller 120 to send data and a write command instructing the non-volatile memory 104 to write the data to the memory array 106. The data and/or the write command may be sent via the connection 118. To send the data and/or the write command, the interface 122 may selectively couple and decouple the connection 118 from the nodes 112, 114 to indicate bit transitions of the data or other signal. For example, the interface 122 may couple the connection 118 to the node 112 via the pMOSFET 312 to charge a voltage at the connection 118 to indicate a logical “1” value to the non-volatile memory 104. The interface 122 may couple the connection 118 to the node 114 via the nMOSFET 316 to partially discharge the voltage to a voltage supply node of the data storage device to indicate a logical “0” value to the non-volatile memory 104.

As used herein, “approximately” may indicate a range of values that is acceptable for a particular context. For example, a transistor size may be approximately X if one of skill in the art would recognize that the transistor size complies with a design specification that specifies that the transistor size should be X (even if the transistor size is not precisely X). Conversely, a transistor size is not approximately X if one of skill in the art would recognize that the transistor size does not comply with a design specification that specifies the transistor size should be X (e.g., due to a process variation of the transistor).

In a particular embodiment, the data storage device 102 may be attached to or embedded within one or more host devices, such as within a housing of a host communication device, which may correspond to the host device 144. For example, the data storage device 102 may be integrated within a packaged apparatus such as a mobile telephone, a music player, a video player, a gaming device or console, an electronic book reader, a personal digital assistant (PDA), a computer, such as a laptop, a tablet, or a notebook computer, a portable navigation device, or other device that uses internal non-volatile memory. However, in other embodiments, the data storage device 102 may be implemented in a portable device configured to be selectively coupled to one or more external devices, such as the host device 144.

To further illustrate, the data storage device 102 may be configured to be coupled to the host device 144 as embedded memory, such as in connection with an embedded MultiMedia Card (eMMC®) (trademark of JEDEC Solid State Technology Association, Arlington, Va.) configuration, as an illustrative example. The data storage device 102 may correspond to an eMMC device. As another example, the data storage device 102 may correspond to a memory card, such as a Secure Digital (SD®) card, a microSD® card, a miniSD™ card (trademarks of SD-3C LLC, Wilmington, Del.), a MultiMediaCard™ (MMC™) card (trademark of JEDEC Solid State Technology Association, Arlington, Va.), or a CompactFlash® (CF) card (trademark of SanDisk Corporation, Milpitas, Calif.). The data storage device 102 may operate in compliance with a JEDEC industry specification. For example, the data storage device 102 may operate in compliance with a JEDEC eMMC specification, a JEDEC Universal Flash Storage (UFS) specification, one or more other specifications, or a combination thereof.

The non-volatile memory 104 may include a three-dimensional (3D) memory, a flash memory (e.g., a NAND memory, a NOR memory, a single-level cell (SLC) flash memory, a multi-level cell (MLC) flash memory, a divided bit-line NOR (DINOR) memory, an AND memory, a high capacitive coupling ratio (HiCR) device, an asymmetrical contactless transistor (ACT) device, or another flash memory), an erasable programmable read-only memory (EPROM), an electrically-erasable programmable read-only memory (EEPROM), a read-only memory (ROM), a one-time programmable memory (OTP), a resistive random access memory (ReRAM), or a combination thereof. Alternatively or in addition, the non-volatile memory 104 may include another type of memory.

The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments. Those of skill in the art will recognize that such modifications are within the scope of the present disclosure.

The above-disclosed subject matter is to be considered illustrative, and not restrictive, and the appended claims are intended to cover all such modifications, enhancements, and other embodiments, that fall within the scope of the present disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
in a data storage device that includes an interface, performing:
charging a voltage at a node of the interface using a first supply voltage; and
partially discharging the voltage to a voltage supply node of the data storage device, wherein the voltage supply node is associated with a second supply voltage.

2. The method of claim 1, wherein the interface communicatively couples a memory of the data storage device and a controller of the data storage device, and wherein the node is an output node of the interface.

3. The method of claim 2, wherein charging the voltage corresponds to communicating a first logical bit from the controller to the memory or from the memory to the controller, and wherein partially discharging the voltage corresponds to communicating a second logical bit from the controller to the memory or from the memory to the controller.

4. The method of claim 2, wherein the first supply voltage is an interface supply voltage that supplies the interface, and wherein the second supply voltage is a core supply voltage that supplies core circuitry of the controller.

5. The method of claim 1, further comprising activating a p-type metal-oxide-semiconductor field-effect transistor (pMOSFET) to charge the voltage at the node.

6. The method of claim 5, further comprising:
deactivating the pMOSFET; and
activating an n-type metal-oxide-semiconductor field-effect transistor (nMOSFET) to partially discharge the voltage.

7. The method of claim 6, wherein a size of the nMOSFET is greater than a size of the pMOSFET.

8. The method of claim 6, further comprising:
generating an overdrive signal at a charge pump based on the first supply voltage; and
driving a gate terminal of the nMOSFET based on the overdrive signal to activate the nMOSFET.

9. The method of claim 8, wherein a size of the pMOSFET is greater than a size of the nMOSFET.

10. The method of claim 1, wherein the first supply voltage and the second supply voltage each have a positive voltage level.

11. The method of claim 1, wherein the first supply voltage has a voltage level of approximately 1.8 volts, and wherein the second supply voltage has a voltage level of approximately 0.9 volts.

12. The method of claim 1, wherein the second supply voltage is a reduced supply voltage.

13. The method of claim 1, further comprising powering core circuitry of the data storage device based at least partially on the discharged voltage.

14. A data storage device comprising:
a voltage supply node; and
an interface, wherein the interface is configured to charge a voltage at a node of the interface using a first supply voltage and to partially discharge the voltage to the voltage supply node, and wherein the voltage supply node is associated with a second supply voltage.

15. The data storage device of claim 14, further comprising:
a memory; and
a controller, wherein the controller is communicatively coupled to the memory via the interface.

16. The data storage device of claim 15, wherein charging the voltage sends a first logical bit from the controller to the memory or from the memory to the controller, and wherein partially discharging the voltage sends a second logical bit from the controller to the memory or from the memory to the controller.

17. The data storage device of claim 15, wherein the first supply voltage is an interface supply voltage that supplies the interface, and wherein the second supply voltage is a core supply voltage that supplies core circuitry of the controller.

18. The data storage device of claim 14, further comprising:
a p-type metal-oxide-semiconductor field-effect transistor (pMOSFET) that is coupled to the node; and
an n-type metal-oxide-semiconductor field-effect transistor (nMOSFET) that is coupled to the voltage supply node.

19. The data storage device of claim 18, wherein a size of the nMOSFET is greater than a size of the pMOSFET.

20. The data storage device of claim 18, further comprising a charge pump that is responsive to the first supply voltage to generate an overdrive signal, wherein the nMOSFET is responsive to the overdrive signal, and wherein a size of the nMOSFET is less than a size of the pMOSFET.
